(19) United States
(12) Patent Application Publication
(10) Pub. No.: US 2009/0308586 A1
(43) Pub. Date: Dec. 17, 2009

(54) COOLING SEMICONDUCTOR-BASED DEVICES ARRANGED IN A GREENHOUSE

(75) Inventor: Henri Tapani Juslen, Kerava (FI)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/306,732

(22) PCT Filed: Jun. 28, 2007
(86) PCT No.: PCT/IB07/52509

§ 371 Date: Dec. 29, 2008

(30) Foreign Application Priority Data
Jul. 4, 2006 (EP) 06116540.3

(51) Int. Cl. F24F 11/053; F28D 15/00; G05D 7/06

(52) U.S. Cl. 165/248; 165/104.34

(57) ABSTRACT

Plant cultivation in a greenhouse (1) may require the use of semiconductor-based devices (6) for a more effective and a more adapted illumination of the plants. The present invention provides a cooling system and a cooling method enabling the use of semiconductor-based devices (6) such as light-emitting diodes mounted on a heat sink (5) for illuminating plants placed in a greenhouse environment. The cooling system is provided with at least one pipe (2) having an incoming end (3) and an outgoing end (4) through which ambient air coming from outside the greenhouse (1) is guided.

### TECHNICAL FIELD OF THE INVENTION

The present invention relates to plant cultivation in greenhouse environment, in particular to a cooling method and a cooling system for semiconductor-based devices arranged in a greenhouse.

### BACKGROUND ART

Plant cultivation in a greenhouse environment requires the use of semiconductor-based devices to an ever-increasing extent. One typical example is the use of light-emitting diodes (LEDs) for illuminating greenhouse plants. Indeed, LEDs provide a wide range of well-defined wavelengths and enable illumination of the plant at a close distance as compared to other type of lamps such as high intensity discharge lamps. In particular, it has been reported that the photosynthetic process is sensitive to illumination wavelength, and that different results are obtained when the plants are illuminated by LEDs than when they are illuminated by conventional light sources such as fluorescent lamps. As an example, EP1300066A1 discloses usage of red light of a wavelength of 600 nm since this corresponds to the highest efficiency in photosynthetic reaction in plants.

On the other hand, it is also known that semiconductor-based devices generate heat under operation, and that overheating could degrade performance of these devices. For LEDs, the optimal operation condition, i.e. the condition at which optimal light output is obtained, is at a temperature of 25° C. and below. Generally, the lower the temperature the better. Thus, semiconductor-based devices should ideally be cooled under operation.

As the temperature of a greenhouse often is relatively high and needs to be carefully controlled, the heat dissipation of semiconductor-based devices located inside a greenhouse is not an easy problem to solve. EP1300066A1 discloses an advanced system for cooling LEDs. LEDs are mounted on one side of a base plate in contact with a piping mounted on the opposite side of the base plate. Cooling water or other cooling medium, such as ethanol or dry air at a temperature of −40 to −80° C., circulates inside the piping. Furthermore, the LEDs are also encapsulated with another base plate, which protects them from the greenhouse environment. However, this arrangement is expensive and energy consuming.

### SUMMARY OF THE INVENTION

In view of the above, an objective of the invention is to reduce the problems of prior art and to provide an inexpensive and non-complex cooling system and cooling method for cooling semiconductor-based devices arranged in a greenhouse.

The present invention is based on the understanding that, in some climatic zones, illumination of greenhouse plants is needed and requires the use of semiconductor-based devices. Semiconductor-based devices can also be employed to illuminate the plants of a greenhouse in order to accelerate plant growth. This is particularly true for climatic zones where ambient temperature, i.e. temperature outside the greenhouse, is low with respect to the temperature required by the greenhouse plants. Hence, the present invention may advantageously be applied in such environments. A basic idea of the present invention is to use ambient air located outside the greenhouse to cool semiconductor-based devices located inside the greenhouse.

According to a first aspect of the present invention, there is provided a cooling system arranged in a greenhouse for cooling semiconductor-based devices used for illumination and mounted on a heat sink, wherein said greenhouse comprises at least one pipe having an incoming end at which a cooling medium is supplied and moves to an outgoing end of said at least one pipe, wherein said heat sink is in thermal contact with said cooling medium located in said at least one pipe, and wherein said cooling medium is ambient air from outside the greenhouse.

According to a second aspect of the present invention, there is provided a method for cooling semiconductor-based devices inside a greenhouse, comprising the steps of acquiring ambient air from outside the greenhouse, guiding said ambient air from outside the greenhouse through said greenhouse, and setting said ambient air from outside the greenhouse in a thermal contact with said semiconductor-based devices.

The main advantages of this cooling system and this cooling method as compared to that described in prior art are that they are inexpensive, less energy consuming and use a cheap and abundant cooling medium.

In a first embodiment of the invention, there is provided a cooling system for bringing ambient air from outside the greenhouse inside the greenhouse by creating a chimney effect. This effect can be achieved using an arrangement where the incoming end of the pipe is at a lower altitude than its outgoing end. This solution is relatively easy to implement and quite inexpensive.

Further, in a second embodiment, a more powerful but slightly less inexpensive solution is provided involving an air controller for controlling the air properties of the ambient air from outside the greenhouse supplied in said at least one pipe. The air controller may be provided with a thermometer and may comprise the functionality of controlling the temperature and the flow of the ambient air from outside the greenhouse supplied in said at least one pipe.

In a third embodiment of the invention, there is provided a cooling system wherein a heat exchanger is arranged at the outgoing end of said at least one pipe for feeding heated pipe air into the greenhouse.

In addition, in a fourth and a fifth embodiment of the invention, there are provided cooling systems wherein the semiconductor-based devices are placed either at the periphery of said at least one pipe or inside said at least one pipe. The embodiment where the semiconductor-based devices of the cooling system are located inside said at least one pipe has the advantage that a high durability of the semiconductor-based devices is guaranteed since the devices are protected against the humidity and the general conditions of the greenhouse atmosphere, which can be detrimental for the functionality of the devices. In relation to this embodiment, another embodiment of the invention is provided where the at least one pipe of the cooling system comprises transparent material.

The present invention may advantageously be applied for cooling semiconductor-based devices such as light-emitting diodes whose ideal working temperature is at about 25° C. and below.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 gives an overview of the cooling system arranged in a greenhouse for cooling semiconductor-based devices according to an embodiment of the present invention.

FIG. 2 gives an overview of the cooling system arranged in a greenhouse for cooling semiconductor-based devices according to further embodiments of the present invention.

### DETAILED DESCRIPTION OF EMBODIMENTS OF THE INVENTION

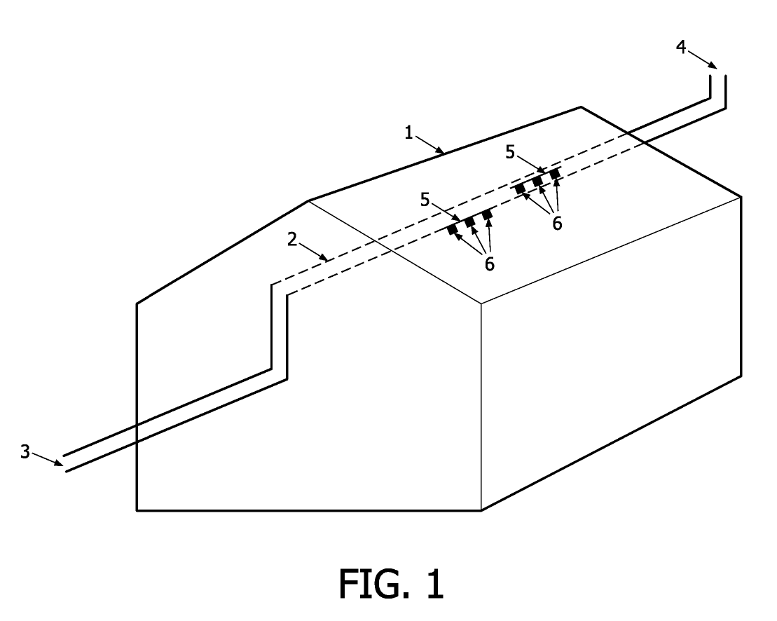

With reference to FIG. 1, a first embodiment of the invention will be described below.

Referring to FIG. 1, a cooling system in the form of at least one pipe 2 is arranged in a greenhouse 1. Alternatively, the cooling system may comprise several pipes or a network of pipes interconnected to each other. The pipe 2 is connected to the outside of the greenhouse 1 from which ambient air is provided. In this embodiment, end 3 is provided to supply the ambient air from outside the greenhouse. However, the cooling system may comprise several ends in order to connect the pipe 2 to the ambient air located outside the greenhouse 1.

The ambient air from outside the greenhouse would preferably be colder than the air located inside the greenhouse when the system operates. Therefore, the present invention is more advantageously applied to countries having a relatively cold climate, in which illumination of the plants is needed.

When the semiconductor-based devices 6 are under operation, they give off heat and transfer their heat to a heat sink 5 on which they are mounted. As a result, the air located in the pipe 2 is heated due to the thermal contact established between the heat sink 5 and the air located in the pipe 2 (as will be explained below). Consequently, this induces motion of the air located inside the pipe 2.

In this embodiment, the incoming end 3 of the pipe 2 is at a lower altitude than the outgoing end 4 of the pipe 2. This creates a chimney effect, i.e. warm air travels in an upward direction. Thus, it is sufficient to turn on the semiconductor-based devices 6 to initiate the motion of the ambient air coming from outside the greenhouse 1. The ambient air will first enter an incoming end 3 of the pipe 2 and then exit the pipe 2 via an outgoing end 4. As a result, said semiconductor-based devices 6 mounted on a heat sink 5, itself in thermal contact with the air located inside the pipe 2, are cooled down and can operate under proper conditions.

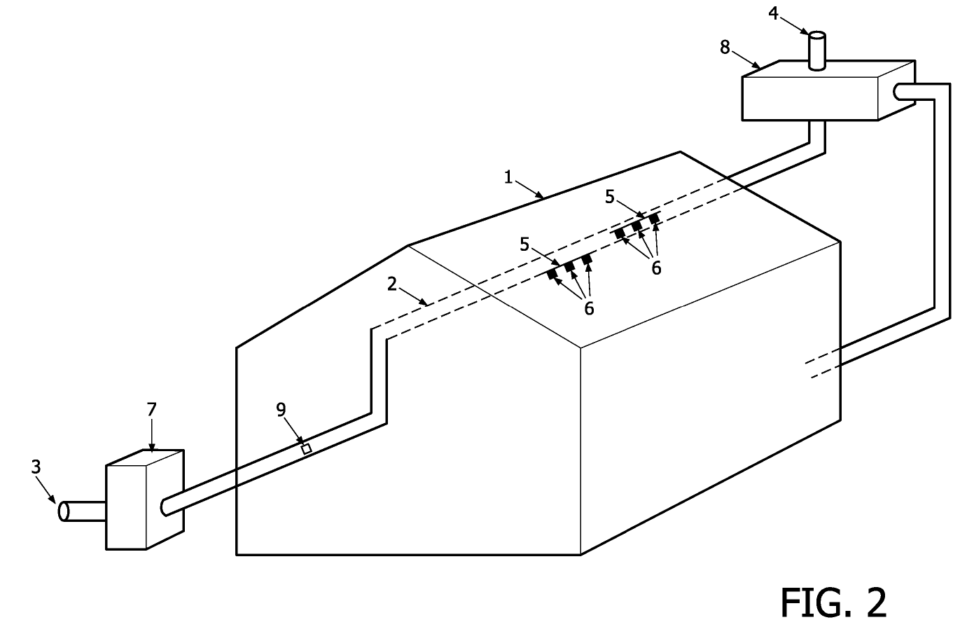

With reference to FIG. 2, further embodiments of the present invention will be described. In FIG. 2, the cooling system is connected to an air controller 7, which is arranged at the pipe 2. The air controller 7 may be a fan, a pump, any other devices of the like or any combination of such devices arranged to generate air motion. The air controller is ideally located at one of the ends of the pipe 2. In this case, the functionality of the cooling system is independent of the difference in altitude of the incoming end 3 with respect to the outgoing end 4. The air controller 7 is turned on when cooling of the semiconductor-based devices 6 is required. The air controller 7 induces motion of the ambient air located outside the greenhouse from one end of the pipe 2 to the other. As a result, the semiconductor-based devices 6 in thermal contact with the air located inside the pipe 2 via the heat sink 5 are cooled down and can operate under proper conditions.

In yet a further embodiment of the present invention, the air controller 7 obtains information from different types of detectors, such as a thermometer 9, and utilizes this information for controlling the properties, such as the temperature or the flow, of the air supplied from the outside of the greenhouse 1 in the pipe 2. This information is for instance used to control the power at which the fan, the pump or other devices of the like will operate. The effect of the motion of the air induced by the air controller 7 is the same as that described above, i.e. the semiconductor-based devices 6 are cooled down.

In another embodiment, the cooling system is provided with a heat exchanger 8 connected to the outgoing end 4 of the pipe 2. The heat exchanger functions as a relay, which either deflates the air coming from the pipe 2 via the outgoing end 4 to the outside of the greenhouse 1 or feeds the air coming from the pipe 2 into the greenhouse 1 for heating.

In the following embodiments of the present invention, different approaches of mounting the semiconductor-based devices 6 in the cooling system are provided.

A first approach is to mount the heat sink 5 of the semiconductor-based devices 6 at the periphery of the pipe 2. In this case, the pipe 2 would ideally comprise a thin material allowing good thermal conduction between the heat sink 5 and the cold air moving in the pipe 2. The heat sink 5 may be located at the outer surface of the periphery or may be part of the material comprising the periphery of the pipe 2. The heat sink comprises material of high heat conductivity such as metal or ceramics in order to efficiently dissipate the heat generated by the semiconductor-based devices 6.

A second approach is to place the semiconductor-based devices 6 and the corresponding heat sink 5 inside the pipe 2. This embodiment presents the advantage of directly setting the semiconductor-based devices 6 in contact with the air coming from the outside of the greenhouse 1. Thus, this embodiment provides a more efficient manner of cooling down the semiconductor-based devices 6. In this case, the pipe 2 comprises material having low heat conductivity such as plastics, glass or material of the like for completely isolating the greenhouse 1 from the air moving inside the pipe 2. In other words, this embodiment enables cooling of semiconductor-based devices placed in a greenhouse using ambient air from outside the greenhouse 1 without cooling and perturbing the greenhouse environment.

To accommodate the cooling system for the embodiment where the semiconductor-based devices 6 are mounted inside the pipe 2, the pipe 2 may comprise transparent material. This will facilitate illumination of the plants of the greenhouse 1 when the semiconductor-based devices 6 are placed inside the at least one pipe 2.

In a further embodiment, the semiconductor-based devices 6 of the cooling system may be light-emitting diodes (LEDs) but are not limited to this type of device. The advantage of using LEDs as compared to more traditional light sources, such as high intensity discharge lamps, is that LEDs can be located very close to the plants and that controlling the illumination characteristics of the LEDs is easy. LEDs exist in a wide range of wavelengths and, based on the information provided by the air controller 7, functionalities such as dimming of the LEDs can be incorporated in the cooling system.

The cooling system provided herein is also adapted for layer cultivation in a greenhouse environment.

The invention has mainly been described above with reference to a number of explicitly disclosed embodiments. However, as is readily appreciated by a person skilled in the art, other embodiments than the ones disclosed above are equally possible within the scope of the invention, as defined by the appended patent claims.

1. A cooling system arranged in a greenhouse for cooling semiconductor-based devices mounted on a heat sink, said cooling system comprising at least one pipe having an incoming end at which a cooling medium is supplied and moves to an outgoing end of said at least one pipe, and wherein said heat sink is in thermal contact with said cooling medium located in said at least one pipe, wherein said cooling medium is ambient air from outside the greenhouse.

2. The cooling system of claim 1, wherein said incoming end of said at least one pipe is at a lower altitude than said outgoing end of said at least one pipe.

3. The cooling system of claim 1, further comprising an air controller for controlling the properties of said ambient air from outside the greenhouse, said air controller being arranged in connection to said at least one pipe.

4. The cooling system of claim 3, wherein said air controller is provided with a thermometer for controlling the temperature of said ambient air from outside the greenhouse based on the temperature measured by the thermometer.

5. The cooling system of claim 3, wherein said air controller controls the flow of said ambient air from outside the greenhouse.

6. The cooling system of claim 1, wherein a heat exchanger (8) is arranged at said outgoing end of said at least one pipe for feeding pipe air into said greenhouse.

7. The cooling system of claim 1, wherein said heat sink is mounted at the periphery of said at least one pipe.

8. The cooling system according to claim 1, wherein said semiconductor-based devices are placed inside said at least one pipe.

9. The cooling system of claim 1, wherein said at least one pipe comprises transparent material.

10. The cooling system of claim 1, wherein said semiconductor-based devices are light emitting diodes.

11. A method for cooling semiconductor-based devices inside a greenhouse, comprising the steps of:
acquiring ambient air from outside the greenhouse;
guiding said ambient air from outside the greenhouse through said greenhouse; and
setting said ambient air from outside the greenhouse in a thermal contact with said semiconductor-based devices.

12. The method according to claim 11, wherein the step of guiding said ambient air from outside the greenhouse is performed by employing a chimney effect between a greenhouse inlet and a greenhouse outlet.

13. The method according to claim 11, further comprising a step of controlling the properties of said ambient air from outside the greenhouse by means of an air controller.

14. The cooling method according to claim 13, wherein the step of controlling the properties of said ambient air from outside the greenhouse comprises controlling the temperature of said ambient air from outside the greenhouse.

15. The cooling method according to claim 13, wherein the step of controlling the properties of said ambient air from outside the greenhouse comprises controlling the flow of said ambient air from outside the greenhouse.
